(19) United States
(12) Patent Application Publication
(10) Pub. No.: US 2024/0349242 A1
(43) Pub. Date: Oct. 17, 2024

(54) INTERMITTENT COVERAGE IN A NON-TERRESTRIAL NETWORK

(71) Applicant: TELEFONAKTIEBOLAGET LM ERICSSON (PUBL), Stockholm (SE)

(72) Inventors: Johan Rune, LIDINGÖ (SE); Emre Yavuz, STOCKHOLM (SE); Helka-Liina MÄÄTTÄNEN, Espoo (FI)

(21) Appl. No.: 18/681,360

(22) PCT Filed: Aug. 5, 2022
(86) PCT No.: PCT/IB2022/057338

§ 371 Date: Feb. 5, 2024

Related U.S. Application Data
(60) Provisional application No. 63/230,022, filed on Aug. 5, 2021.

(51) Int. Cl. H04W 68/02; H04B 7/185; H04W 76/28

(52) U.S. Cl. CPC H04W 68/02; H04B 7/18589; H04W 76/28

(57) ABSTRACT

According to some embodiments, a method is performed by a wireless device for adapting to intermittent network coverage in a non-terrestrial network (NTN). The method comprises: receiving information indicative of the availability of NTN network access; and determining whether the wireless device is within or outside of an area with NTN network access based in part on the received information and a location of the wireless device. Upon determining that the wireless device is outside the area with NTN network access, the wireless device operates in a reduced power mode in which one or more internal processes are suspended or disabled. Upon determining that the wireless device is within the area with NTN network access, the wireless device operates in a normal power mode in which one or more of the internal processes that were suspended or disabled are reactivated or enabled.

### TECHNICAL FIELD

Embodiments of the present disclosure are directed to wireless communications and, more particularly, to supporting intermittent network coverage in a non-terrestrial network (NTN).

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

The Third Generation Partnership Project (3GPP) unites telecommunications standard development organizations and provides an environment to produce the reports and specifications that define 3GPP technologies. 3GPP specifies the evolved packet system (EPS). EPS is based on the long-term evolution (LTE) radio network and the evolved packet core (EPC). EPS was originally intended to provide voice and mobile broadband (MBB) services but has continuously evolved to broaden its functionality. 3GPP also specifies narrowband Internet of Things (NB-IoT) and LTE for machines (LTE-M) as part of the LTE specifications and provide connectivity to massive machine type communications (mMTC) services.

3GPP also specifies the 5G system (5GS). This is a new generation radio access technology intended to serve use cases such as enhanced mobile broadband (eMBB), ultra-reliable and low latency communication (URLLC) and mMTC. 5G includes the new radio (NR) access stratum interface and the 5G Core Network (5GC). The NR physical and higher layers reuse parts of the LTE specification, and to that add needed components when motivated by the new use cases. One such component is a sophisticated framework for beam forming and beam management to extend the support of the 3GPP technologies to a frequency range going beyond 6 GHz.

In 3GPP release 15, 3GPP started the work to prepare NR for operation in a non-terrestrial network (NTN) (e.g., satellite communications). The work was performed within the study item “NR to support Non-Terrestrial Networks” and resulted in TR 38.811. In 3GPP release 16, the work to prepare NR for operation in an NTN network continued with the study item “Solutions for NR to support Non-Terrestrial Network”. In parallel the interest to adapt NB-IoT and LTE-M for operation in NTN is growing. As a consequence, 3GPP release 17 contains both a work item on NR NTN and a study item on NB-IoT and LTE-M support for NTN.

In 3GPP NTN includes both satellite communication and communications using high-altitude platforms (HAPS). In this section we focus on satellite communication, but the provided description could also be applied to a HAPS network. A satellite radio access network usually includes the following component: a satellite that refers to a space-borne platform; an earth-based gateway that connects the satellite to a base station or a core network, depending on the choice of architecture; a feeder link that refers to the link between a gateway and a satellite; and an access link that refers to the link between a satellite and a UE.

Depending on the orbit altitude, a satellite may be categorized as low earth orbit (LEO), medium earth orbit (MEO), or geostationary earth orbit (GEO) satellite. LEO includes typical heights ranging from 250-1,500 km, with orbital periods ranging from 90-120 minutes. MEO includes typical heights ranging from 5,000-25,000 km, with orbital periods ranging from 3-15 hours. GEO includes height at about 35,786 km, with an orbital period of 24 hours.

A communication satellite typically generates several beams over a given area. The footprint of a beam is usually in an elliptic shape, which has been traditionally considered as a cell. The footprint of a beam is also often referred to as a spotbeam. The footprint of a beam may move over the earth surface with the satellite movement or may be earth fixed with some beam pointing mechanism used by the satellite to compensate for its motion. The size of a spotbeam depends on the system design, which may range from tens of kilometers to a few thousands of kilometers.

FIG. 1 illustrates an example architecture of a satellite network with bent pipe transponders. The depicted elevation angle of the service link is important because it impacts the distance between the satellite and the device, and the velocity of the satellite relative to the device.

In a LEO or MEO communication system, a large number of satellites deployed over a range of orbits are required to provide continuous coverage across the full globe. FIG. 2 is reproduced from TR 38.821 and illustrates LEO 600 km constellation providing full coverage in the S-band. The example consists of 17 orbits, with each orbit defined by 30 satellites, each generating 469 beams. A total of 17×30=510 satellites produce 17×30×469=239,190 beams. If each satellite supports less beams, then the number of satellites needs to be increased beyond 510 to achieve full earth-coverage.

Launching a mega satellite constellation is both an expensive and time-consuming procedure. It is therefore expected that all LEO and MEO satellite constellations for some time will only provide partial earth-coverage. For constellations dedicated to massive IoT services with relaxed latency requirements, support for full earth-coverage may not be necessary. Providing occasional or periodic coverage according to the orbital period of the constellation may be sufficient.

FIG. 3 illustrates an example of a constellation defined by seven satellites distributed over three orbits, with each satellite generating 469 beams, as it provides coverage for parts of western Africa.

A 3GPP device in RRC_IDLE or RRC_INACTIVE state is required to perform a number of procedures including measurements for mobility purposes, paging monitoring, tracking area update, and search for a new public land mobile network (PLMN) to mention a few. These procedures consume power in devices, and a general trend in 3GPP has been to allow for relaxation of these procedures to prolong device battery life. This trend has been especially pronounced for IoT devices supported by NB-IoT and LTE-M.

There currently exist certain challenges. For example, a 3GPP device camping on a network expects continuous network availability. This stands in stark contrast to the moving radio access network (RAN) associated with a LEO or MEO NTN not providing full earth-coverage. In many such scenarios, especially during the early stages of satellite deployments, there will not be enough satellites in orbit to provide continuous coverage. Instead, network coverage will only be intermittently (e.g., periodically) available, which will cause the device to waste power by performing RRC_IDLE and RRC_INACTIVE procedures during time periods when there is no RAN available.

In HAPS (or HIBS) and in GEO networks, solar powered satellite and HAPS base stations (or HIBS) may not be powered when the earth shadows the sun. Also, in this scenario the RAN they serve may only be periodically available, i.e. during sun-hours, and a similar problem as described above for LEO and MEO NTN arises. These problems are addressed in part in PCT Application PCT/SE2021/050087, which is incorporated herein by reference. The present disclosure provides additional solutions, addressing further aspects.

Some additional problems addressed herein include the lack of details about how coverage areas may be described; how coverage timing information may be adapted to different locations (e.g., specific or potential user equipment (UE) locations), e.g., in relation to the line drawn on the ground by the cell center, or nadir direction, of a moving cell. Current systems also do not account for the borders of a coverage area (e.g., a cell or a spot beam) being inherently fuzzy, because the signal strength gradually decreases rather than disappears sharply.

### SUMMARY

Based on the description above, certain challenges currently exist with intermittent network coverage a non-terrestrial network (NTN). Certain aspects of the present disclosure and their embodiments may provide solutions to these or other challenges. For example, particular embodiments disclosed herein include additional ways to describe (configure) periodic and non-periodic network coverage revisiting times, improved description (configuration) of coverage area shapes, adaptation of network coverage area information or calculation to specific locations, e.g., user equipment (UE) locations, accounting for the inherent fuzziness of network coverage borders, and optimizations (in both the UE and the network) for adapting to intermittent network coverage.

In particular embodiments, optimizations for adapting to intermittent network coverage include the following: suspension of cell search during periods without network coverage; suspension of page monitoring during periods without network coverage; adaptation of paging occasions to the periods of network availability and network unavailability for a UE; suspension of neighbor cell measurements (in RRC_IDLE, RRC_INACTIVE and RRC_CONNECTED state) during periods without network coverage; suspension, in the UE, of periodic registration and/or periodic RAN-based notification area (RNA) update during periods without network coverage; suspension, in the network, of reachability timers related to periodic registration and/or periodic RNA update during periods when the concerned UE lacks network coverage; suspension of system information acquisition during periods without network coverage, e.g. refraining from attempting to acquire fresh system information until network coverage is regained, even though the validity of the system information stored in the UE has expired; suspension, in the network, of UE reachability timer during periods when the concerned UE lacks network coverage; adaptation of eDRX cycles to a UE's periods of network availability and unavailability; adaptation of DRX cycles in RRC_CONNECTED state (C-DRX cycles) to a UE's periods of network availability and unavailability; and UE autonomous suspension from RRC_CONNECTED state to RRC_INACTIVE state when going from network availability to network unavailability, and resumption to RRC_CONNECTED state when network coverage returns.

According to some embodiments, a method is performed by a wireless device for adapting to intermittent network coverage in a NTN. The method comprises: receiving information indicative of the availability of NTN network access; and determining whether the wireless device is within or outside of an area with NTN network access based in part on the received information and a location of the wireless device. Upon determining that the wireless device is outside the area with NTN network access, the wireless device operates in a reduced power mode in which one or more internal processes are suspended or disabled. Upon determining that the wireless device is within the area with NTN network access, the wireless device operates in a normal power mode in which one or more of the internal processes that were suspended or disabled are reactivated or enabled.

In particular embodiments, operating in the reduced power mode comprises modifying wireless device configuration, such as one or more of: entering an inactive state; adapting paging occasions to periods of network availability and network unavailability; and adapting discontinuous reception cycles to periods of network availability and unavailability.

In particular embodiments, operating in the reduced power mode comprises suspending a wireless device operation, such as suspending one or more of: cell search; page monitoring; neighbor cell measurements; periodic registration; periodic area updates; system information acquisition; and reachability timer monitoring.

In particular embodiments, operating in the normal power mode of operation comprises modifying wireless device configuration, such as one or more of: entering a connected state; adapting paging occasions to periods of network availability and network unavailability; and adapting discontinuous reception cycles to periods of network availability and unavailability.

In particular embodiments, operating in the normal power mode of operation comprises resuming a wireless device operation, such as resuming one or more of: cell search; page monitoring; neighbor cell measurements; periodic registration; periodic area updates; system information acquisition; and reachability timer monitoring.

In particular embodiments, receiving information indicative of the availability of NTN network access comprises one or more of: receiving information related to a shape, size, center, movement, or orientation of an area covered by NTN network access; receiving explicit information about where NTN network access exists; receiving explicit information about where NTN network access is absent; receiving information about one or more borders associated with an area covered by NTN network access; and receiving coverage timing information indicating when an area will be covered by NTN network access.

According to some embodiments, a wireless device comprises processing circuitry operable to perform any of the wireless device methods described above.

A computer program product comprises a non-transitory computer readable medium storing computer readable program code, the computer readable program code operable, when executed by processing circuitry to perform any of the methods performed by the wireless device described above.

According to some embodiments, a method is performed by a network node for adapting to intermittent network coverage in a NTN. The method comprises: providing a wireless device with information indicative of the availability of NTN network access; obtaining location information associated with the wireless device; and determining whether the wireless device is within or outside of an area with NTN network access based in part on the information indicative of the availability of NTN network access and the obtained location of the UE. Upon determining that the wireless device is outside the area with NTN network access, the method comprises determining that the wireless device is using a reduced power mode of operation in which one or more internal processes are suspended or disabled. Upon determining that the wireless device is within the area with NTN network access, the method comprises determining that the wireless device is using a normal power mode of operation in which one or more of the internal processes that were suspended or disabled are reactivated or enabled.

In particular embodiments, upon determining that the wireless device is outside the area with NTN network access, the method further comprises any one or more of: suspending a network reachability timer for the wireless device, adapting a discontinuous reception cycle for the wireless device based in part on the information indicative of the availability of NTN network access and the obtained location of the wireless device; and determining the wireless device autonomously suspended to an inactive state.

In particular embodiments, upon determining that the UE is within the area with NTN network access, the method further comprises any one or more of: resuming a network reachability timer for the wireless device; adapting a discontinuous reception cycle for the wireless device based in part on the information indicative of the availability of NTN network access and the obtained location of the wireless device; and determining the wireless device autonomously resumed to an active state.

In particular embodiments, providing the wireless device with information indicative of the availability of NTN network access comprises providing any one or more of: information related to a shape, size, center, movement, or orientation of an area covered by NTN network access; providing explicit information about where NTN network access exists; providing explicit information about where NTN network access is absent; providing information about one or more borders associated with an area covered by NTN network access, and providing coverage timing information indicating when an area will be covered by NTN network access.

According to some embodiments, a network node comprises processing circuitry operable to perform any of the network node methods described above.

Another computer program product comprises a non-transitory computer readable medium storing computer readable program code, the computer readable program code operable, when executed by processing circuitry to perform any of the methods performed by the network node described above.

Certain embodiments may provide one or more of the following technical advantages. For example, the embodiments disclosed herein enable optimized UE (and network) operation in the presence of intermittent NTN coverage.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example architecture of a satellite network with bent pipe transponders;

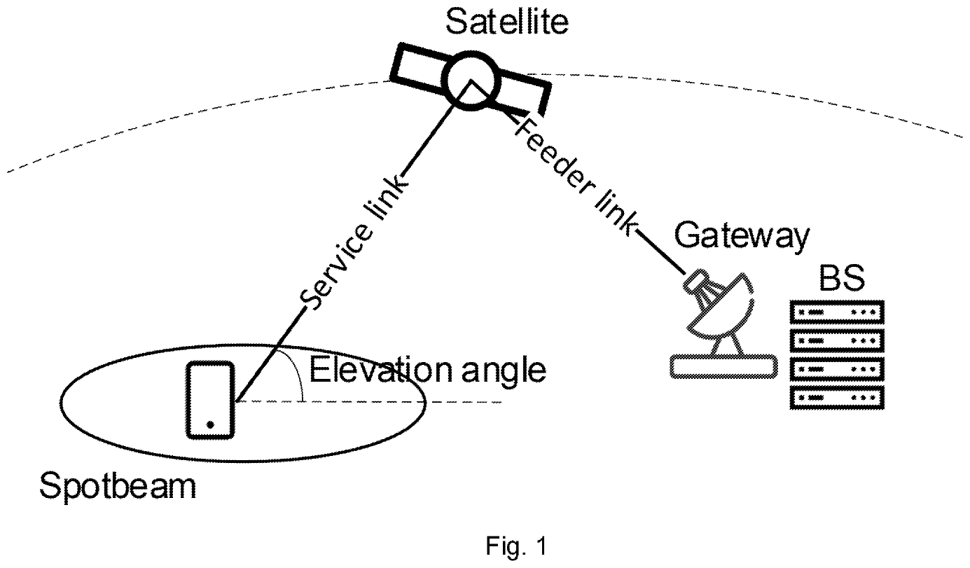

FIG. 2 is reproduced from TR 38.821 and illustrates LEO 600 km constellation providing full coverage in the S-band;

FIG. 3 illustrates an example of a constellation defined by seven satellites distributed over three orbits;

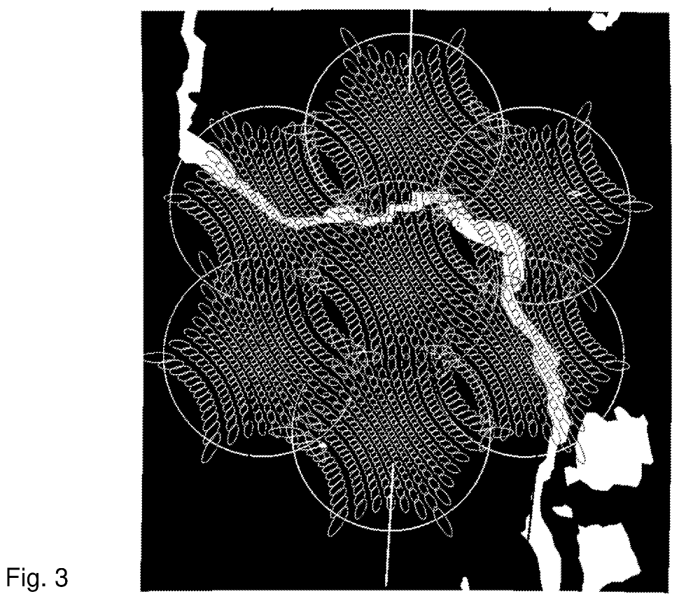

FIG. 4 is a block diagram illustrating an example wireless network;

FIG. 5 illustrates an example user equipment, according to certain embodiments;

FIG. 6A is a flowchart illustrating an example method in a wireless device, according to certain embodiments;

FIG. 6B is a flowchart illustrating an example method in a network node, according to certain embodiments;

FIG. 7 illustrates a schematic block diagram of a wireless device in a wireless network, according to certain embodiments;

FIG. 8 illustrates an example virtualization environment, according to certain embodiments;

FIG. 9 illustrates an example telecommunication network connected via an intermediate network to a host computer, according to certain embodiments; and

FIG. 10 illustrates an example host computer communicating via a base station with a user equipment over a partially wireless connection, according to certain embodiments.

### DETAILED DESCRIPTION

Based on the description above, certain challenges currently exist with intermittent network coverage a non-terrestrial network (NTN). Certain aspects of the present disclosure and their embodiments may provide solutions to these or other challenges. For example, particular embodiments disclosed herein include additional ways to describe (configure) periodic and non-periodic network coverage revisiting times, improved description (configuration) of coverage area shapes, adaptation of network coverage area information or calculation to specific locations, e.g., user equipment (UE) locations, accounting for the inherent fuzziness of network coverage borders, and optimizations (in both the UE and the network) for adapting to intermittent network coverage.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. Although particular problems and solutions may be described using new radio (NR) terminology, it should be understood that the same solutions apply to long term evolutions (LTE) and other wireless networks as well, where applicable.

As used herein, the term “coverage timing information” denotes information that informs a UE of which time period or time periods (repetitive or other) network coverage will be provided at a particular location, e.g. the user equipment (UE) location, or a particular area. The terms “network coverage” and “network availability” are used interchangeably herein, as are the terms “lack of network coverage”, “absence of network coverage”, “absence of network availability” and “network unavailability.”

Previously, it has been described that an NTN RAN, providing periodic coverage at a specific geographical location, configures UEs with coverage timing information that may be modeled as a network availability timer. The timer is defined by a period P, an offset O in the period, and has a length L wherein, the period P may, e.g., correspond to the periodicity for which a moving RAN revisits, i.e., provides coverage at, the particular location. The period P may alternatively correspond to the time when the nodes in a RAN are powered and are able to provide service. The offset O determines from when in the period the RAN provides coverage. The length L determines for how long the coverage is expected to be provided, i.e., the duration of one occurrence of the periodic network coverage.

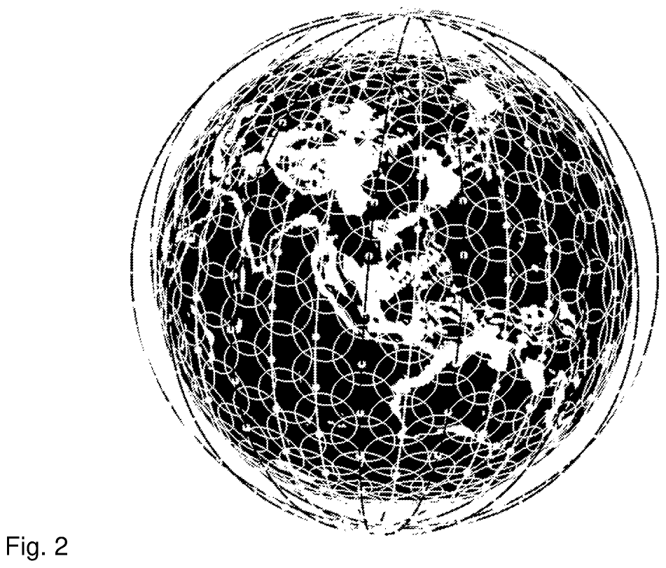

These values may be based on the RAN moving, e.g., a LEO or MEO NTN, and the revisiting period P is dependent, e.g., on the satellite ephemeris, the offset O is determined based on the particular geographical location relative to the orbit, and the length L is determined by the size of the area covered by the moving RAN. The timer associated with the period P starts over every time a satellite passes over a reference location (e.g., in one example of polar orbits, as illustrated in FIG. 2, a timer P is started, and stopped, as a satellite passes over the North pole (90° North Latitude). The offset O may be determined by each UE based on the UE location relative to a reference location.

In a simple example, a satellite has a polar orbit (i.e., the orbit passes above the North Pole and the South Pole) and the timer P is (re-)started every time the satellite passes over the North Pole. Further, in this example, the North Pole is used as the reference location and a UE located at the North Pole would thus configure the offset O to 0 seconds.

Particular embodiments described herein take into account that the time period with network coverage starts before the center of the cell, or coverage area, passes the reference location, i.e., North Pole in the concerned example (the satellite provides coverage on the North Pole some time before the satellite passes on top of the North Pole, assuming a moving cell served by a spot beam, or spot beam bundle, pointing in the nadir direction). With the offset, O, defined as the time in the period P at which the coverage starts, the offset should not coincide with the passage of the center of the coverage area, e.g., when the satellite is in the nadir direction. Thus, in an embodiment where the satellite's passage over the reference location (as seen with the nadir direction) marks the start and end of a period P, the offset should be set to indicate a time before the end of the time period P. Assuming a coverage area that is symmetric around the nadir direction, the offset may be set to O=P−L/2.

Other ways exist to compensate for the distance (and resulting time difference) between the edge of the coverage area and the center of the coverage area. As one example, the reference location may be redefined from the nadir satellite position to a position that sets the reference location at the edge of the coverage area, or by giving the UE some information about the size of the coverage area. Another way is to define that the length (duration) of the coverage time, L, is centered around the point in time when the satellite is at the reference location (assuming nadir beam direction and assuming the reference location defined in the nadir direction from the satellite), i.e., in line with what was described in the example above. Because coverage, and in particular a coverage area border, in the context of cellular networks, in particular NTNs, is an inherently fuzzy concept, this definition of L makes it easy for a UE implementation to decide to optimistically assume that in a moving cell scenario, it will be able to receive signals from (and transmit signals to) the satellite even slightly before its “official” coverage duration has started (and slightly after it has ended) as indicated by the parameters P, O and L.

Furthermore, in some embodiments, the UE autonomously adapts the signaled length (i.e., duration) parameter L based on the UE location and its distance to the above mentioned reference location or to the center of the coverage area (where the coverage area's shape and size may, as one option, be signaled to the UE(s) together with the coverage timing information) or to the satellite orbit's projection on the ground. As an extension to this embodiment, the UE(s) may be provided with the coverage area's shape and size, e.g., through signaling, such as RRC signaling, either in the form of broadcast system information or in the form of dedicated signaling. Area descriptions and signaling of such are described in more detail below.

In some legacy systems, the satellite constellation signals its ephemeris data and an approximation of its moving coverage area to the UEs where satellite constellation may consist of a single satellite or multiple satellites. Based on these parameters, the UE determines when the network is not available. In particular embodiments described herein, based on the signaled information about the moving coverage area (including the ephemeris data of the satellite(s)), and possibly the earth's rotation, together with knowledge of its own position, a UE may calculate the periods in time when the coverage area of the satellite will cover the UE location.

In some legacy systems, an NTN coverage area (e.g., a coverage area that moves and provides intermittent coverage) corresponds to the aggregated footprint of all beams supported by the satellite constellation and may be defined by a center point and a geometric shape, e.g., a circle, an ellipse, a hexagon, or a square. The center point may be defined at a position relative to nadir of a satellite in the satellite constellation, and will move along with the satellite.

When the satellite constellation consists of multiple satellites, the footprint of each satellite may be defined by a center point (or other reference point) and a geometric shape. In some embodiments, any other point than the center point of the coverage area may serve as the reference point. In addition, unless the shape is rotation symmetric (i.e., unless the shape is a circle), the description of the coverage area may include information about the shape's directional orientation in the horizontal plane (or on the surface of the earth).

For example, if the shape is a square, the directional orientation may describe which directions the square's corners point to (e.g., North, South, East, West, southwest, northeast, etc.). One way to indicate the directional orientation is to define a second reference point on the shape and then indicate the horizontal angle (e.g., azimuth) between North (or another earth-fixed reference direction) and a line or vector (which may be denoted the shape's reference line or reference vector) between the two reference points. Alternatively, the directional information may have the form of an angle between the reference line, or reference vector, and the satellite orbit's projection on the earth's surface.

The type of parameters describing a certain shape (e.g., circle diameter, side length of a square, or, for an ellipse, either the lengths of the semi-minor axis and the semi-major axis or the linear eccentricity together with one of the semi-minor axis and semi-major axis or the distance between the focuses and one of the semi-minor axis and the semi-major axis) are preferably standardized, including where on the shape the reference point or reference points is/are located. Multiple different shapes may have their respective “blueprints” standardized in this way. For the directional information, it may be standardized that the horizonal angle relative to North (or another earth-fixed reference direction) is used to indicate the horizontal direction of the shape (and for each shape, it may be standardized which line, e.g., between two reference points as described above, the angle is measured from/to). Alternatively, because the shape's angle in relation to an earth-fixed direction may change as the coverage area follows the satellite as it moves along its orbit, an alternative is to provide the directional information in terms of an angle relative the satellite orbit (or the orbit's projection on the earth surface) rather than an angle relative an earth-fixed direction (such as North).

When the shape is signaled to the UE, these standardized parameters are given values that characterize the concerned shape. Such signaling may be conveyed using, e.g., broadcast system information or dedicated signaling. Even standardizing a complete shape with all its parameter values fixed is an option. As a hybrid approach, multiple different shapes may be standardized (including values of their describing characterizing parameters), including different sizes or different directional orientations of the same shape, each given a reference, such as an index. The NTN may signal one such reference to the UEs, e.g., in the form of an index. This provides a compact way of signaling the required information, at the expense of some lost flexibility (where the flexibility is limited by the number of standardized shapes (including sizes and directional orientations).

There is some freedom in the choice of parameters used to describe a particular shape, because there are different ways to unambiguously indicate shape, size and direction. The choice of parameters is not critical, as long as the chosen parameter unambiguously describes a shape, including its size and direction, but the set of parameters to be used for a particular shape may be defined, e.g., standardized. There are already such shape parameters standardized in 3GPP TS 23.032, which specifies “Universal Geographical Area Description (GAD)” and, as one option, these parameters may be reused, possibly after extending them with more parameters, e.g., describing more shapes.

In some legacy systems, the network signals to a UE, during a current period of coverage provided to the geographic location of the UE by a satellite, the next time any satellite of the same NTN visits and provides coverage on the same geographic location, or in case of a HAPS (or HIBS) or GEO based NTN the next time the satellite is powered and provides services. Accordingly, in particular embodiments the network signals a non-periodic schedule of periods of coverage and periods without coverage, which is valid for a certain time into the future. This may include cases where the schedule is actually periodic, but it is a complex pattern of periods of coverage and periods without coverage that is repeated with a certain periodicity.

In another context, the UE may be preconfigured, or UE may acquire from system information or dedicated RRC signaling, an index base for location reporting. This may be specific to a certain area UE is assumed to be, or it may convey the entire world, a continent, or country. In some embodiments, the indexing is reused in the context of providing the intermittent coverage information. The indexing may associate one bit information of coverage/no coverage to an index representing a local area of some form or shape. The indexing may be timing information that gives additional time information when the local area has NTN coverage and/or when the local NTN does not have coverage. In some embodiments, covering physical cell identity (PCI) information is added.

In some legacy systems, the coverage timing information may be adapted to specific locations (e.g., the offset parameter O may depend on the UE location relative to a reference location). In particular embodiments, adapting coverage timing information to specific locations supports intermittent network coverage and these embodiments are described in more detail below. These embodiments may be used together with periodic coverage timing information (a period together with a simple coverage/non-coverage duty cycle or more complex periodic coverage/non-coverage time patterns) and forms of non-periodic coverage timing information, such as indicating the next time a location will be covered.

In some embodiments, the network provides coverage timing information, e.g., coverage repetition parameters, to a specific UE, where the coverage timing information is tailored for the UE, based on location information from the UE or UE location information obtained through other means, e.g., network based methods.

In some embodiments (mainly targeting a moving cells scenario), the network provides the same coverage timing information, e.g., coverage repetition parameters, to multiple UEs, e.g., all UEs in a cell or a beam coverage area. In this case, one or multiple instances of coverage timing information is/are provided, each associated with a certain reference location and wherein the reference locations are suitably distributed to give a broad picture of the coverage timing situation across an area. Because the coverage timing situation may vary between different locations, the multiple instances of coverage timing information may not contain exactly the same information (although the differences between the instances will typically be small if the concerned reference locations are contained within a comparatively small area, such as a cell or a beam coverage area).

Each UE, which typically is located somewhere in the area over which the reference locations are distributed, but not exactly at a reference location, may use two or more of the reference locations closest to the UE's location and interpolate the coverage timing information associated with the two or more reference locations to derive the coverage timing information at the UE's location. In the special case where the UE is located more or less precisely at a reference location, the UE may only use the coverage timing information associated with this reference location. Another special case is that the provided coverage information contains only one reference location. In this case, a UE may use a default algorithm to calculate the coverage information on the UE's own location, e.g., based on the distance, and possibly direction, between the reference location and the UE's location.

To assist this calculation, the coverage timing information may include geographic or spatial coverage information, e.g., in the form of the shape (including size and directional orientation) of the coverage area and/or an indication of how one or more coverage information parameter(s) depend on the distance (and optionally direction) from the reference location. This may, e.g., assist the UE in estimating the duration (length) of a coverage period close to the edge of the coverage area compared with the duration (length) of the coverage period when the center of the coverage area passes the concerned location, e.g., when the single reference location is located at the center of the coverage area. Although this is most relevant for the case where only one reference location is provided, such geographic or spatial coverage information (and possibly distance (and possibly direction) dependence information) may be used also together with multiple reference locations.

In some embodiments, the network provides network coverage information that depends (at least in part) on the distance from the satellite's orbit projection on the ground. For example, the duration (length) of a coverage period, e.g., a repetitive coverage period, may depend on the distance from satellite's orbit projection on the ground.

As described above, the borders of a coverage area, e.g. a cell, are inherently fuzzy in the sense that the signal strength gradually decreases with increasing distance from the spot where the maximum signal strength is experienced (where the experienced signal strength also depends on the properties of the UE receiver). This has similar implications on the time periods of network coverage and lack of network coverage. This aspect of intermittent coverage is not accounted for in legacy systems, but particular embodiments addressing this are described below.

In practice, the area or time period within which network coverage is provided may be fuzzy in the sense that coverage may gradually fade in or out. This may motivate indications of fuzzy start and end of coverage periods or fuzzy borders of coverage areas. For example, one way to reflect this fuzziness in the related configuration is to provide a UE with an indication of a width of the border, either in time or in geography. This may be modeled as a single border together with a border width parameter. Another way to model a fuzzy border is to use an inner and an outer border, where the coverage, e.g., in terms of received downlink signal strength, such as reference signal receive power (RSRP), decreases from a larger value at the inner border to a lower value at the outer border. With this approach, the inner and outer borders may be configured such that the desired signal strength values result at the respective borders.

There are different ways to express this. One way is a pure relative approach, where the goal is that the signal strength at the outer border should be a certain fraction of the signal strength at the inner border (i.e. a ratio with linear scale measures (e.g., watts) or a dB difference with a logarithmic scale).

Another principle is to relate the maximum signal strength in the cell, e.g., the nadir direction (i.e., the center of the cell) in the moving cells case where a satellite serves a cell with a spot beam (or spot beam bundle in case of a multi-beam cell) in the nadir direction. Then the inner and outer border may be configured where the signal strengths at the two borders are two respective fractions of the maximum signal strength in the cell (or coverage area). For example, with a linear scale, the inner border may be configured such that the signal strength at the inner border is X % of the cell's maximum signal strength, while the outer border may be configured such that the signal strength at the outer border is Y % of the cell's maximum signal strength (where X and Y could be e.g., X=30% and Y=10%). Translated to the logarithmic domain, this means that the inner border may be configured such that the signal strength at the inner border is Z dB of the cell's maximum signal strength, while the outer border is configured such that the signal strength at the outer border is Q dB of the cell's maximum signal strength (where Z and Q could be e.g., Z=−5.2 dB and Q=−10 dB).

As one option, when/if dedicated signaling (e.g., an RRCReconfiguration message or an RRCRelease message) is used to convey the coverage timing information (including the inner and outer borders), the UE may request which estimated relative signal strength values the borders should correspond to. The UE may base such a request on knowledge of its receiver properties (e.g., a UE with a sensitive receiver may request borders that correspond to relative signal strength values that are smaller fractions than a UE with less sensitive receiver might request.

The UE may acquire such knowledge about its receiver properties (e.g., the receiver sensitivity) through experience, e.g., learning how successful it is in receiving downlink signals (and its success in other communication) with borders corresponding to different relative signal strengths. The UE may systematically investigate this by varying the estimated relative signal strength values it requests the network to configure borders corresponding to in successive requests. Another way for the UE to acquire knowledge about its receiver properties (e.g., the sensitivity) is through hardcoding (i.e., the information is hardcoded/configured into the UE during implementation and manufacturing). The option that the UE may request which estimated relative signal strength values the borders should correspond to may also be used in a variant where only a single coverage area border is used (in which case the request will contain only a single requested estimated relative signal strength value).

Another approach is to configure the inner and outer borders so that a certain selected absolute value of a signal strength quantity (e.g., RSRP measured in dBm or a power related quantity measured in Watts) are experienced at the respective border. However, the received signal strength, such as the RSRP, is a UE-subjective measure, which does not only depend on the transmission power and the attenuation and other channel properties during the propagation, but also on the properties of the UE receiver. Therefore, a reference receiver model with well-defined properties may be used when estimating where the borders should be (in time and/or geography to correspond to the desired/selected signal strengths.

In conjunction with estimated relative signal strength values corresponding to the borders, as one option when/if dedicated signaling (e.g., an RRCReconfiguration message or an RRCRelease message) is used to convey the coverage area information (including the inner and outer borders) to the UE, a UE may request which estimated signal strength value (e.g., RSRP value) each border should correspond to. The UE may base such a request on knowledge of its own receiver properties (e.g., the receiver sensitivity and whether its receiver sensitivity is higher than or lower than the sensitivity of the reference receiver model), wherein the UE may acquire such knowledge through hardcoding (i.e., the information is hardcoded/configured into the UE during implementation and manufacturing) or through learning (e.g., by comparing the signal strengths it receives at borders or border passages with the estimated signal strength values the borders are supposed to correspond to, where these estimated values may be known because they were requested by the UE or they may be specified default values or they may be signaled together with the coverage timing information). The option that the UE may request which estimated signal strength values the borders should correspond to may also be used in a variant where only a single coverage area border is used (in which case the request will contain only a single requested estimated signal strength value).

One option in conjunction with dual coverage borders (i.e., an inner and an outer border), the UE's behavior, or strategy, is that when the coverage is approaching, the UE starts monitoring the downlink signals from the network at the outer border, but not expect good (or indeed any) coverage before the inner border. Conversely, the UE's behavior when the coverage is moving away from the UE may be that the UE keeps monitoring the network until the outer border, but be prepared to lose coverage at any time after the inner border has been crossed.

Optionally, the UE may “activate” a configured or standardized signal strength threshold, e.g., an RSRP threshold, when the inner border is crossed while coverage is moving away from the UE and consider network coverage to be lost and stop monitoring the network if the RSRP goes below the threshold, even if the outer border is not reached yet. Some embodiments may depend on the data category, or QoOS for the data whether the UE attempts to connect at outer boarder or is expected to wait until coverage is better. In this way, low signal strength areas can be reserved to very urgent data and less urgent data can wait until there is better capacity to serve the UEs.

The concept where the coverage area border's fuzziness is captured by configuring an inner and an outer border may be used in conjunction with suspension of UE procedures in RRC_IDLE, RRC_INACTIVE or RRC_CONNECTED state. For example, the suspension and resumption of procedures may be triggered at the inner border or at the outer border. Alternatively, suspension of procedures may be triggered at the outer border while resumption of procedures may be triggered by the inner border. As another alternative, suspension of procedures may be triggered by the inner border while resumption of procedures may be triggered by the outer border. Different trigger alternatives may be used for different procedures.

Another alternative is that the UE, when the inner border is crossed while coverage is moving away from the UE, this may trigger the UE to monitor a signal strength threshold, e.g. an RSRP threshold, which, when the signal strength/RSRP goes below the threshold (potentially during a time to trigger (TTT) time period), triggers suspension of procedures. Similarly, when coverage is approaching the UE and the outer border is crossed, this may trigger the UE to start monitoring a signal strength threshold (e.g., an RSRP threshold), which, when the RSRP goes above the threshold (potentially during a TTT time period), triggers resumption of procedures (where the thresholds for suspension and resumption may be the same or different thresholds).

The threshold(s) may be configured via broadcast system information or dedicated signaling (e.g., using an RRCReconfiguration message or an RRCRelease message) or may be specified in a standard. An option for the threshold configuration is to configure one explicit threshold value and then the difference between this threshold value and the value of the other threshold. Another option is to configure a threshold value and a hysteresis span to be applied to the threshold value to derive the values for the respective two thresholds. If the difference parameter or hysteresis span parameter is set to zero, or is absent, this means that only a single threshold (to be used both when the coverage is moving towards the UE and when it is moving away from the UE) is configured.

Different thresholds may be configured or specified for different UE procedures. In some embodiments, the RSRP thresholds are broadcast in system information and whether the UE applies inner or outer border when suspending is configured in an RRCReconfiguration message or an RRCRelease message.

The concept of configuring more than one coverage area border to capture the fuzziness of a coverage area border may in some embodiments be generalized to more than two borders, e.g. an arbitrary number of borders, e.g. N borders where N>1. In the variants, the borders may be translated into geography or time, e.g., the timepoints for a UEs, or a reference location's, estimated passage of each border.

UE and network procedures in all states may be more or less adapted to intermittent network coverage to improve various properties, such as UE energy consumption, UE reachability and network resource utilization.

In some legacy systems, a UE is only mandated to perform RRC_IDLE and RRC_INACTIVE procedures when the network is indicated to be available, i.e., may provide service to a UE. During times of network unavailability, the UE may suspend all or a set of the RRC_IDLE and RRC_INACTIVE procedures. In some embodiments, the UE may suspend cell search during periods without network coverage (as indicated by the received coverage timing information). As another example, the UE may suspend page monitoring and/or measurements for cell reselection assessment purpose during time periods without network availability/coverage, in particular intra-frequency measurements. The UE may also suspend a timer for periodic registration (where periodic registration is realized through a NAS Registration Request message with the 5GS registration type parameter set to “periodic registration updating”) and/or (in RRC_INACTIVE state) a timer for periodic RNA update (where periodic RNA update is realized through an RRCResumeRequest message with the resumeCause parameter set to “rna-Update” while the UE is still located within its configured RNA).

Furthermore, the UE may suspend acquisition of system information. For example, if the validity of system information stored in the UE expires (which it typically does after three hours), the UE may wait until it regains network coverage (according to received coverage timing information or according to detection of network availability) before trying to acquire fresh system information. As one example, the UE may thus treat coverage timing information received through system information as valid while waiting to regain network coverage, even though the “official” validity time of the information has expired.

On the network side, the network may suspend timers that are irrelevant while the UE is out of coverage, such as a timer for monitoring UE reachability by monitoring periodic registrations (where such a timer would be managed by a core network node such as an access and mobility management function (AMF)) or a timer for monitoring UE reachability by monitoring periodic RAN updates (where such a timer would be managed by the RAN, e.g., a gNB). In addition, the network may buffer arriving downlink traffic while the UE is out of network coverage, and page the UE when the UE again is covered by the network (i.e., a cell covers the UE location), Similarly, RRC_CONNECTED state procedures, such as neighbor cell measurements and measurement reporting, may be suspended during time periods when the UE lacks network coverage. Also, radio link monitoring (RLM) may be suspended during time periods without network coverage, so that radio link failure cannot be determined during such time periods. On the network side, the network may, for example, suspend a UE inactivity timer while the UE is temporarily out of coverage, and the network may buffer arriving downlink traffic until the UE is in coverage (and reachable) again.

In some legacy systems, periodic activities, e.g., DRX or eDRX periods for paging, are adjusted to match the satellite availability. This can be done in at least the following two ways in legacy systems.

The first way is by assigning an eDRX period such that it is equal to the to the satellite orbit periodicity (or multiples thereof) whereby the UE's paging time window (PTW) is aligned with the satellite passage. This may further be quantized to the defined paging occasions (POs) of the network. Using multiple satellites in the same orbit allows for phase shifted eDRX periods.

The second way is by assigning one or more PO(s) to a UE immediately or soon following upon the satellite coming within range of the UE (i.e., immediately or soon after the UE has regained network coverage), even if the UE is not otherwise configured to be attentive to this/those PO(s) from its DRX and eDRX periodicities (and the associated regular PO derivation algorithm). This may facilitate both paging and data delivery within a single satellite passage, thereby minimizing latency.

In legacy systems in which one or more PO(s) is/are assigned to a UE immediately (or soon) after the point in time where it has regained network coverage (outside the regular PO schedule), particular embodiments add, as one option, the association of one or more PO(s) immediately or soon after the UE has regained network coverage is done only if at least one PO, as derived from the regular PO derivation algorithm for the UE, occurred during the preceding period of lack of network coverage.

Furthermore, particular embodiments provide the following additional method for adaptation of the POs to the intermittent network coverage. A rule is added to the regular PO derivation algorithm, stating that periods when the network does not provide coverage at the UE's location are regarded as DRX or eDRX sleep periods, regardless of possible PO(s) indicated by the regular PO derivation algorithm. In other words, POs derived using the regular PO derivation algorithm that occur during periods without network coverage are ignored.

In one variant, only the UE ignores such POs, while the network may still use them for paging the UE. In this variant, the network has to be prepared to repeat the paging in sufficiently many POs to ensure that the UE is paged in at least a minimum number (which can be one or more) of PO(s) during which the UE has network coverage. One way the network can achieve this is to ensure that the repeated pages span a time period longer than the maximum out-of-coverage period for a location. This variant may be suitable when the network's awareness of the location of the UE to be paged is coarse such that the area in which the UE to be paged may be located (based on the network's coarse knowledge) may be large, e.g. when the UE's paging area, e.g. the area indicated by the UE's allocated list of Tracking Areas, is significantly larger than the coverage area provided by a satellite (or HAPS/HIBS).

In another variant, both the UE and the network ignores the POs that, based on the regular PO derivation algorithm, occur in periods when the UE does not have network coverage. This variant may be suitable when the network has sufficiently accurate knowledge of the UE's location, e.g. when the UE's paging area, e.g. the area indicated by the UE's allocated list of Tracking Areas, is comparatively small, e.g. smaller than, or has a similar size as, the coverage area provided by a satellite (or HAPS/HIBS).

Furthermore, as previously mentioned, an option on the network side is that the network may buffer arriving downlink traffic while the UE is out of network coverage, and page the UE when the UE again is covered by the network (i.e., a cell covers the UE's location), e.g. using a PO that is assigned to the UE outside the regular PO derivation algorithm (as described above), The downlink traffic may be buffered either in the core network or in the RAN.

The DRX configuration that may optionally be provided to a UE in RRC_CONNECTED state (referred to as C-DRX) may be adapted to intermittent network coverage/availability in similar ways as described above for DRX/eDRX for paging in RRC_IDLE and RRC_INACTIVE state. This may include, e.g., adaptation of the C-DRX cycle to the presence and absence of network coverage/availability, in particular when the presence of network coverage/availability is periodic. Another type of C-DRX adaptation is to configure a C-DRX active period at the start of each period of network coverage/availability. This may be done on top of the regular C-DRX cycle or the C-DRX cycle may be adapted to achieve this purpose. Yet another way of C-DRX adaptation to the presence and absence of network coverage/availability is to configure (or specify in standard) a rule to be used on top of the C-DRX cycle (and sleep/active algorithm), stating that periods without network coverage/availability at the UE's location shall be regarded and treated as C-DRX sleep periods.

In some embodiments, a UE in RRC_CONNECTED state may be configured to autonomously enter RRC_INACTIVE state during periods when the UE lacks network coverage and resume to RRC_CONNECTED state when network coverage returns to the UE's location. As one option, these state transitions are governed by the information the UE has received regarding availability of network coverage, i.e., when this information indicates that the UE goes from network availability to network unavailability, this triggers suspension to RRC_INACTIVE state, and when the network availability/unavailability information indicates that the UE goes from network unavailability to network availability, this triggers resume to RRC_CONNECTED state. As another option, the UE's measurements/detections of network availability and network unavailability triggers the suspension and resumption. The resume operation may be silent (i.e., implicit without signaling) or explicit, requiring an RRCResumeRequest message from the UE (followed by an RRCResume message from the network), or optionally, the resume operation may consist of an RRCResume message from the network without a preceding RRCResumeRequest message from the UE. The network may configure relevant RRC_INACTIVE related parameters for the UE beforehand, such as an I-RTNI and an RNA. With this feature, the UE's RRC_INACTIVE state behavior may be different from a UE's behavior in “regular” RRC_INACTIVE state. Thus, an option is to define/specify this state as a different state than RRC_INACTIVE state (with different associated messages and/or parameters when relevant).

Earth fixed cells may be provided by stationary (i.e., hovering over the earth's surface) HAPS/HIBS, geostationary satellites, or LEO/MEO satellites with directional antennas that compensate for the satellite movement to ensure that a satellite's spot beam(s) keep covering the same earth fixed area. For HAPS/HIBS or GEO satellites, intermittent network coverage of an earth fixed area is an effect of the HAPS/HIBS or GEO satellite being powered on and off (or its service of the area is turned on or off), e.g., as a result of varying exposure of the HAPS′/HIBS' or GEO satellite's solar panel to sun light. For LEO/MEO satellites serving an earth fixed cell, intermittent coverage may also result from sparse satellite deployment, such that there is not always a LEO/MEO satellite available to serve the earth fixed cell.

In earth fixed cells deployment, only the cell availability timing information (on/off of service) is relevant in the context of intermittent coverage. This is the same in the entire cell area and is thus independent of the UE's location (such as the UE's distance to the satellite orbit's projection on the ground). In earth fixed cell scenarios, the information the UE requires to determine when network coverage will be available and when it will be unavailable may thus be simpler in earth fixed cells deployments than in the moving cells deployments.

In practice, however, when an earth fixed cell is served by a LEO/MEO satellite, the actual coverage area, i.e. the actual cell area, will vary slightly with the satellite movements, because in practice it is difficult to provide coverage on exactly the same area independently of the satellite's elevation angle. Thus, as one option, the network may provide a UE with information about the cell coverage area, e.g., how it varies with time or with the serving satellite's elevation angle. As another option, the UE may calculate the variations of the cell's coverage area (e.g., the shape of the cell) based on the elevation angle of the serving satellite (which, e.g., may be calculated based on the satellite's ephemeris data) and possibly the spatial relation between the earth fixed cell and the satellite's orbit (e.g., the distance between the cell center and the satellite's orbit projection on the ground).

The particular embodiments described above have mainly been directed toward the aspect of when and where a UE will be provided with network coverage. However, the embodiments outlined below use the opposite viewing angle, i.e., focusing on providing a UE with information about areas and/or time periods without network coverage, i.e., when and where a UE cannot expect to be covered by an NTN cell. An area without network coverage is henceforth referred to as a “no-coverage area” and a time period without network coverage is henceforth referred to as a “no-coverage period”.

To support this approach, the concept of dummy satellites is introduced. A dummy satellite in this context is a “fictive” (non-existent) satellite, which is leveraged as a tool for “packaging” information about no-coverage areas and no-coverage periods. In a similar way as assistance information related to a real satellite, e.g. ephemeris data and/or beam (and cell) property information, may be used to derive information about the coverage provided by the satellite, similar assistance information related to a dummy satellite may be used to derive information about lack of coverage (e.g., no-coverage areas and no-coverage periods).

Areas lacking network coverage may at any given time be scattered areas of various shapes and sizes and because a no-coverage area is what is left when the areas where coverage is provided are “removed”, a no-coverage area may have an irregular shape. To support such scenarios, multiple dummy satellites and associated assistance information may be used, which may be combined to indicate complex area shapes. In addition, taking the potential irregular shape of a no-coverage area into account, as one option, a no-coverage area shape may be signaled in the assistance information, e.g., together with ephemeris data and possibly beam information of a dummy satellite, where the shape may be described using various geometry-related parameters that capture the properties of a shape, e.g., the corners of a polygon, or any other shape related parameters. New area definitions and definition methods may be specified for this purpose and may use the shape describing means specified in 3GPP TS 23.032, which specifies “Universal Geographical Area Description (GAD)”, optionally with extended value ranges of some parameters to support larger areas than anticipated in 3GPP TS 23.032. The no-coverage area shape information (which includes information that makes size and orientation unambiguous) together with the orbital information (e.g., ephemeris data) of the dummy satellite (which describes how the dummy satellite fictively moves) and a spatial relation between the location of the no-coverage area and the dummy satellite (e.g., provided by dummy satellite beam information, such as beam direction or beam angle in relation to the earth's surface or dummy satellite elevation angle) describe how the no-coverage area moves over the surface of the earth.

When this type of information is signaled to a UE, the UE can derive the shapes and locations of no-coverage areas (at any given time), as well as determine expected no-coverage periods at the any given location, e.g., the UE's current location.

The above described embodiments providing no-coverage information using dummy satellite(s) with associated assistance information may be combined with various previously described embodiments targeting information about coverage areas and network coverage in general, e.g., to increase the accuracy in the determination of no-coverage areas and no-coverage periods, e.g., adapted to the UE's specific location. The combination of coverage information and no-coverage information may also provide richer information to the UE, e.g., enabling more precise determination of the edges of coverage areas.

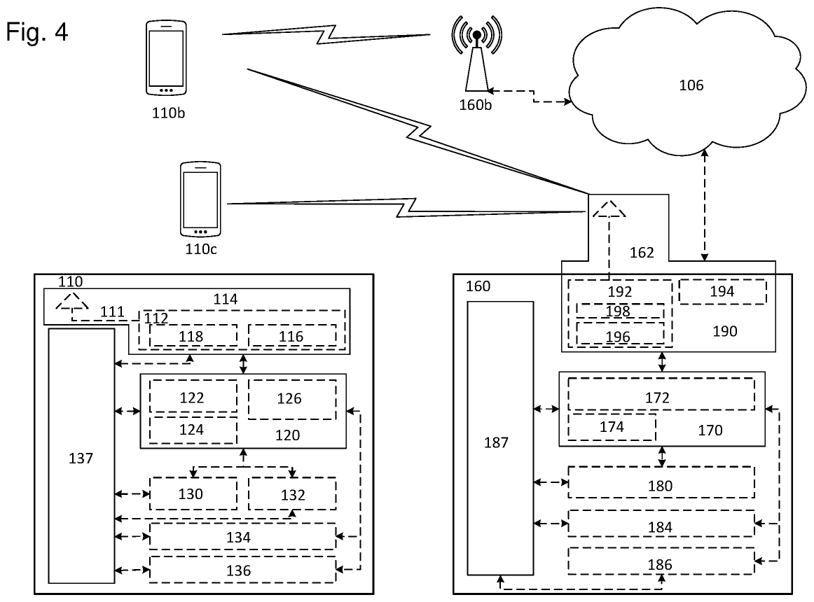

FIG. 4 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 4, network node 160 includes processing circuitry 170, device readable medium 180, interface 190, auxiliary equipment 184, power source 186, power circuitry 187, and antenna 162. Although network node 160 illustrated in the example wireless network of FIG. 4 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHZ. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 4 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g., refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 4. For simplicity, the wireless network of FIG. 4 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

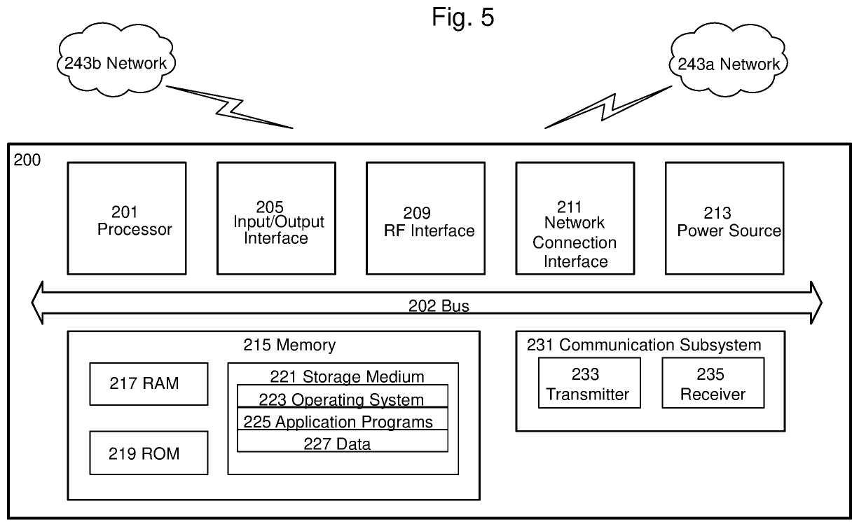

FIG. 5 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 5, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 5 is a UE, the components discussed herein are equally applicable to a WD, and vice-versa.

In FIG. 5, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may use all the components shown in FIG. 5, or only a subset of the components. The level of integration between the components may vary from one UE to another UE. Further, certain UEs may contain multiple instances of a component, such as multiple processors, memories, transceivers, transmitters, receivers, etc.

In FIG. 5, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 5, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 5, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

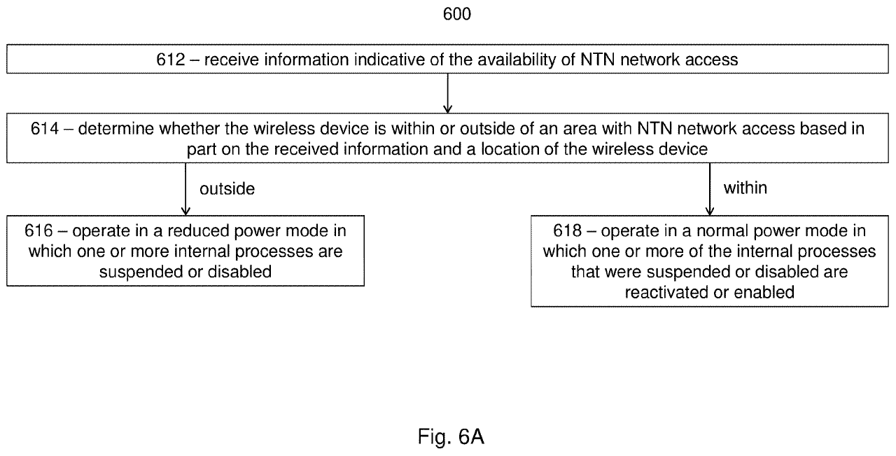

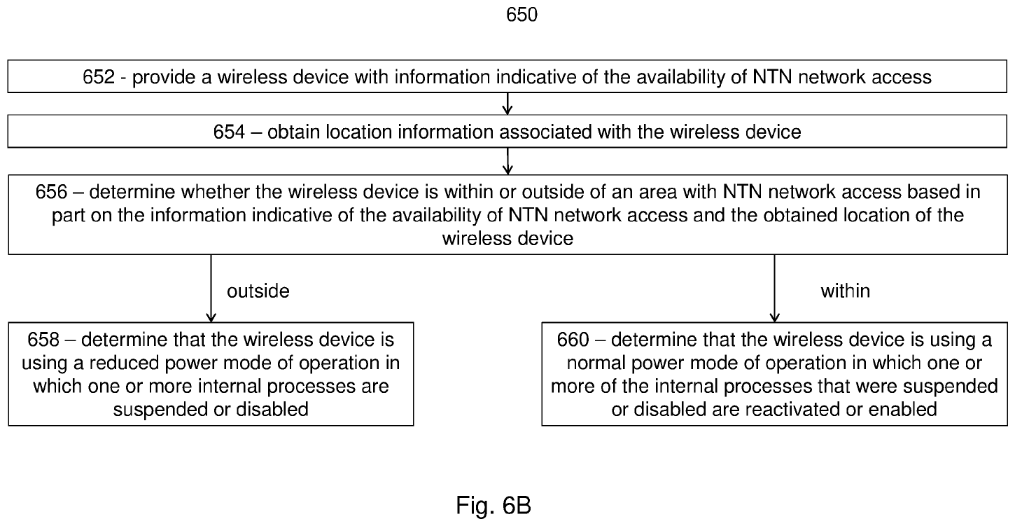

FIG. 6A is a flowchart illustrating an example method in a wireless device, according to certain embodiments. In particular embodiments, one or more steps of FIG. 6A may be performed by wireless device 110 described with respect to FIG. 4. The wireless device is operable to adapt to intermittent network coverage in a NTN.

The method begins at step 612, where the wireless device (e.g., wireless device 110) receives (e.g., via any one or more of broadcast system information, direct signaling such as RRC signaling, etc.) information indicative of the availability of NTN network access. In particular embodiments, receiving information indicative of the availability of NTN network access comprises one or more of: receiving information related to a shape, size, center, movement, or orientation of an area covered by NTN network access (as described in the embodiments and examples described above); receiving explicit information about where NTN network access exists; receiving explicit information about where NTN network access is absent; receiving information about one or more borders associated with an area covered by NTN network access (e.g., single and/or multiple borders with varying thresholds as described in the embodiments and examples above); and receiving coverage timing information indicating when an area will be covered by NTN network access according to any of the embodiments and examples described above.

At step 614, the wireless device determines whether the wireless device is within or outside of an area with NTN network access based in part on the received information and a location of the wireless device, according to any of the embodiments and examples described above.

Upon determining that the wireless device is outside the area with NTN network access, the method continues to step 616, where the wireless device operates in a reduced power mode in which one or more internal processes are suspended or disabled.

In particular embodiments, operating in the reduced power mode comprises modifying wireless device configuration, such as one or more of: (autonomously) entering an inactive state; adapting paging occasions to periods of network availability and network unavailability; and adapting discontinuous reception cycles (DRX, eDRX, C-DRX, etc.) to periods of network availability and unavailability.

In particular embodiments, operating in the reduced power mode comprises suspending a wireless device operation, such as suspending one or more of: cell search; page monitoring; neighbor cell measurements; periodic registration; periodic area updates; system information acquisition; and reachability timer monitoring.

Upon determining that the wireless device is within the area with NTN network access, the method continues to step 618, where the wireless device operates in a normal power mode in which one or more of the internal processes that were suspended or disabled are reactivated or enabled.

In particular embodiments, operating in the normal power mode of operation comprises modifying wireless device configuration, such as one or more of: entering a connected state; adapting paging occasions to periods of network availability and network unavailability; and adapting discontinuous reception cycles to periods of network availability and unavailability.

In particular embodiments, operating in the normal power mode of operation comprises resuming a wireless device operation, such as resuming one or more of: cell search; page monitoring; neighbor cell measurements; periodic registration; periodic area updates; system information acquisition; and reachability timer monitoring.

Modifications, additions, or omissions may be made to method 600 of FIG. 6A. Additionally, one or more steps in the method of FIG. 6A may be performed in parallel or in any suitable order.

FIG. 6B is a flowchart illustrating an example method in a network node, according to certain embodiments. In particular embodiments, one or more steps of FIG. 6B may be performed by network node 160 described with respect to FIG. 4. The network node is operable to adapt to intermittent network coverage in a NTN.

The method may begin at step 652, where the network node (e.g., network node 160) provides a wireless device receives (e.g., via any one or more of broadcast system information, direct signaling such as RRC signaling, etc.) with information indicative of the availability of NTN network access.

In particular embodiments, providing the wireless device with information indicative of the availability of NTN network access comprises providing any one or more of: information related to a shape, size, center, movement, or orientation of an area covered by NTN network access; providing explicit information about where NTN network access exists; providing explicit information about where NTN network access is absent; providing information about one or more borders associated with an area covered by NTN network access, and providing coverage timing information indicating when an area will be covered by NTN network access.

The network node may provide information according to any of the embodiments and examples described herein.

At step 654, the network node obtains location information associated with the wireless device according to any of the embodiments and examples described herein.

At step 656, the network node determines whether the wireless device is within or outside of an area with NTN network access based in part on the information indicative of the availability of NTN network access and the obtained location of the UE, according to any of the embodiments and examples described herein.

Upon determining that the wireless device is outside the area with NTN network access, the method continues to step 658, where the network node determines that the wireless device is using a reduced power mode of operation in which one or more internal processes are suspended or disabled.

In particular embodiments, upon determining that the wireless device is outside the area with NTN network access, the method further comprises any one or more of: suspending a network reachability timer for the wireless device, adapting a discontinuous reception cycle (e.g., DRX, eDRX, C-DRX, etc.) for the wireless device based in part on the information indicative of the availability of NTN network access and the obtained location of the wireless device; and determining the wireless device autonomously suspended to an inactive state.

Upon determining that the wireless device is within the area with NTN network access, the method continues to step 660, where the network node determines that the wireless device is using a normal power mode of operation in which one or more of the internal processes that were suspended or disabled are reactivated or enabled.

In particular embodiments, upon determining that the UE is within the area with NTN network access, the method further comprises any one or more of: resuming a network reachability timer for the wireless device; adapting a discontinuous reception cycle for the wireless device based in part on the information indicative of the availability of NTN network access and the obtained location of the wireless device; and determining the wireless device autonomously resumed to an active state.

Modifications, additions, or omissions may be made to method 650 of FIG. 6B. Additionally, one or more steps in the method of FIG. 6B may be performed in parallel or in any suitable order.

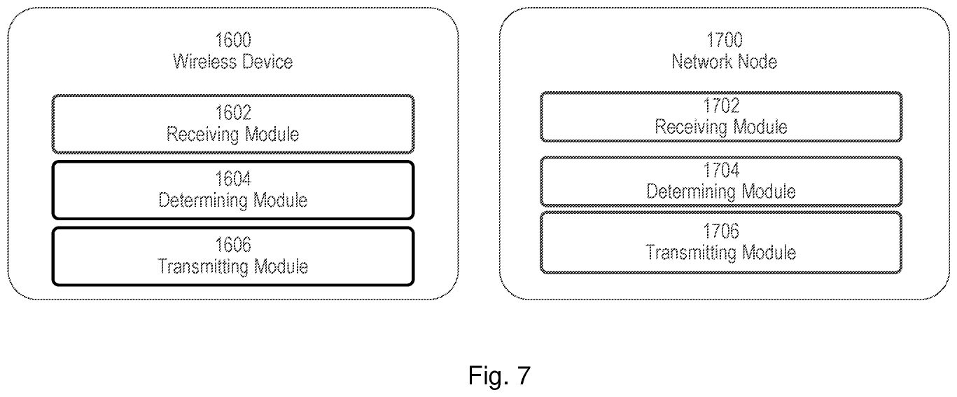

FIG. 7 illustrates a schematic block diagram of two apparatuses in a wireless network (for example, the wireless network illustrated in FIG. 4). The apparatuses include a wireless device and a network node (e.g., wireless device 110 and network node 160 illustrated in FIG. 4). Apparatuses 1600 and 1700 are operable to carry out the example methods described with reference to FIGS. 6A and 6B, respectively, and possibly any other processes or methods disclosed herein. It is also to be understood that the methods of FIGS. 6A and 6B are not necessarily carried out solely by apparatuses 1600 and/or 1700. At least some operations of the methods can be performed by one or more other entities.

Virtual apparatuses 1600 and 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

In some implementations, the processing circuitry may be used to cause receiving module 1602, determining module 1604, transmitting module 1606, and any other suitable units of apparatus 1600 to perform corresponding functions according one or more embodiments of the present disclosure. Similarly, the processing circuitry described above may be used to cause receiving module 1702, determining module 1704, transmitting module 1706, and any other suitable units of apparatus 1700 to perform corresponding functions according one or more embodiments of the present disclosure.

As illustrated in FIG. 5, apparatus 1600 includes receiving module 1602 configured to receive information indicative of the availability of NTN network access according to any of the embodiments and examples described herein. Determining module 1604 is configured to and determining whether the wireless device is within or outside of an area with NTN network access based in part on the received information and a location of the wireless device according to any of the embodiments and examples described herein. Transmitting module 1606 is configured to transmit control information and user data according to any of the embodiments and examples described herein.

As illustrated in FIG. 5, apparatus 1700 includes receiving module 1702 configured to obtain location information associated with the wireless device according to any of the embodiments and examples described herein. Determining module 1704 is configured to determine whether the wireless device is within or outside of an area with NTN network access based in part on the information indicative of the availability of NTN network access and the obtained location of the wireless device according to any of the embodiments and examples described herein. Transmitting module 1706 is configured to transmit information indicative of the availability of NTN network access to a wireless device, according to any of the embodiments and examples described herein.

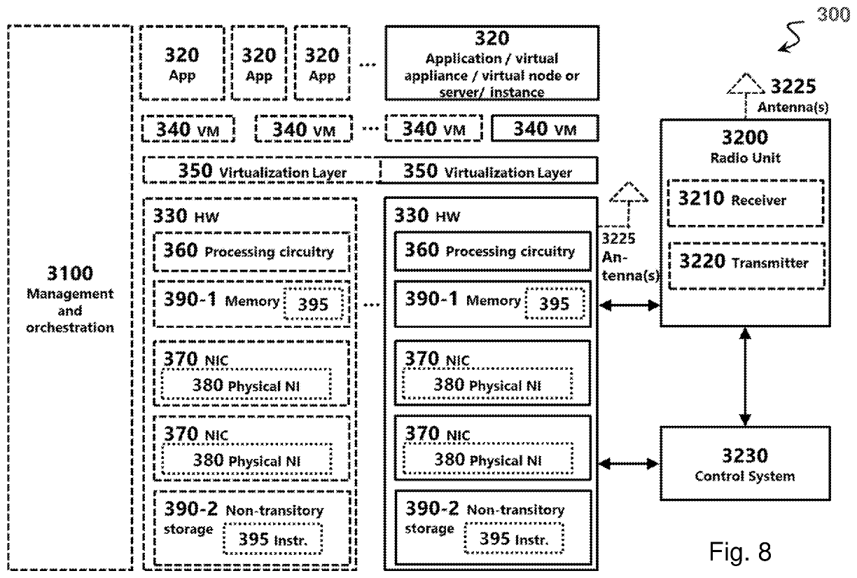

FIG. 8 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 8, hardware 330 may be a standalone network node with generic or specific components. Hardware 330 may comprise antenna 3225 and may implement some functions via virtualization. Alternatively, hardware 330 may be part of a larger cluster of hardware (e.g., such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 18.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be effected with the use of control system 3230 which may alternatively be used for communication between the hardware nodes 330 and radio units 3200.

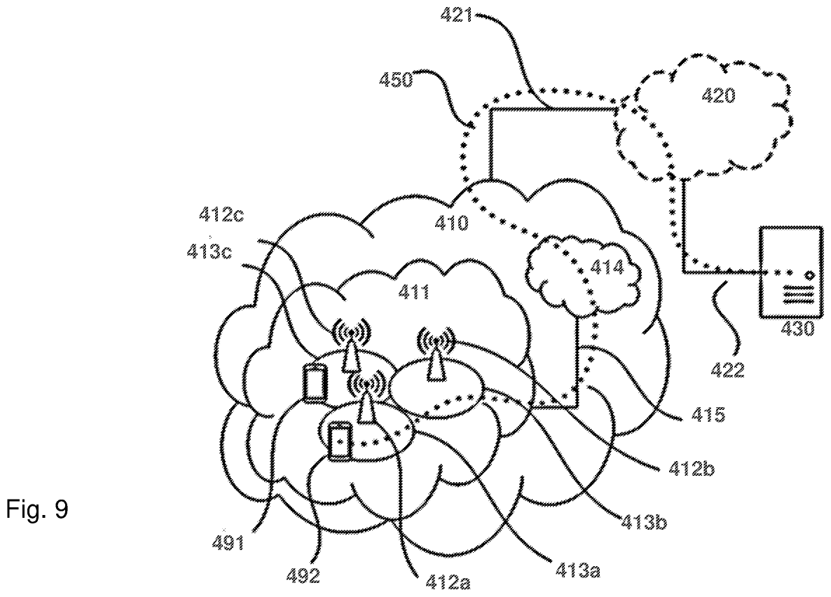

With reference to FIG. 9, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 9 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

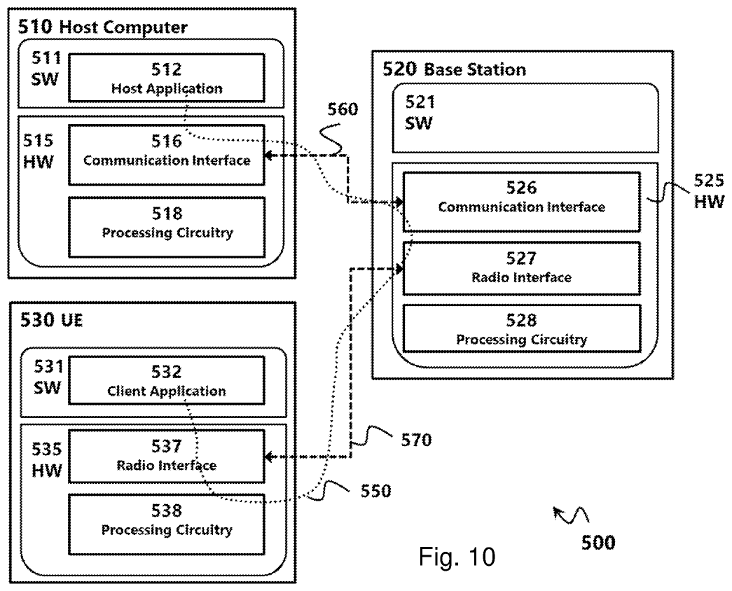

FIG. 10 illustrates an example host computer communicating via a base station with a user equipment over a partially wireless connection, according to certain embodiments. Example implementations, in accordance with an embodiment of the UE, base station and host computer discussed in the preceding paragraphs will now be described with reference to FIG. 10. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 10) served by base station 520. Communication interface 526 may be configured to facilitate connection 560 to host computer 510. Connection 560 may be direct, or it may pass through a core network (not shown in FIG. 10) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 10 may be similar or identical to host computer 430, one of base stations 412a, 412b, 412c and one of UEs 491, 492 of FIG. 4, respectively. This is to say, the inner workings of these entities may be as shown in FIG. 10 and independently, the surrounding network topology may be that of FIG. 4.

In FIG. 10, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., based on load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the signaling overhead and reduce latency, which may provide faster internet access for users.

A measurement procedure may be provided for monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

1. A method performed by a wireless device for adapting to intermittent network coverage in a non-terrestrial network (NTN), the method comprising:
receiving information indicative of the availability of NTN network access;
determining whether the wireless device is within or outside of an area with NTN network access based in part on the received information and a location of the wireless device;
upon determining that the wireless device is outside the area with NTN network access, operating in a reduced power mode in which one or more internal processes are suspended or disabled; and
upon determining that the wireless device is within the area with NTN network access, operating in a normal power mode in which one or more of the internal processes that were suspended or disabled are reactivated or enabled.

2. The method of claim 1, wherein operating in the reduced power mode comprises modifying wireless device configuration.

3. The method of claim 2, wherein modifying wireless device configuration comprises one or more of:
entering an inactive state;
adapting paging occasions to periods of network availability and network unavailability; and
adapting discontinuous reception cycles to periods of network availability and unavailability.

4. The method of claim 1, wherein operating in the reduced power mode comprises suspending a wireless device operation.

5. The method of claim 4, wherein suspending the wireless device operation comprises suspending one or more of:
cell search;
page monitoring;
neighbor cell measurements;
periodic registration;
periodic area updates;
system information acquisition; and
reachability timer monitoring.

6. The method of claim 1, wherein operating in the normal power mode of operation comprises modifying wireless device configuration.

7. The method of claim 6, wherein modifying wireless device configuration comprises one or more of:
entering a connected state;
adapting paging occasions to periods of network availability and network unavailability; and
adapting discontinuous reception cycles to periods of network availability and unavailability.

8. The method of claim 1, wherein operating in the normal power mode of operation comprises resuming a wireless device operation.

9. The method of claim 8, wherein resuming the wireless device operation comprises resuming one or more of:
cell search;
page monitoring;
neighbor cell measurements;
periodic registration;
periodic area updates;
system information acquisition; and
reachability timer monitoring.

10. The method of claim 1, wherein receiving information indicative of the availability of NTN network access comprises one or more of:
receiving information related to a shape, size, center, movement, or orientation of an area covered by NTN network access;
receiving explicit information about where NTN network access exists;
receiving explicit information about where NTN network access is absent;
receiving information about one or more borders associated with an area covered by NTN network access; and
receiving coverage timing information indicating when an area will be covered by NTN network access.

11. A wireless device capable of operating in a non-terrestrial network (NTN), the wireless device comprising processing circuitry operable to:
receive information indicative of the availability of NTN network access;
determine whether the wireless device is within or outside of an area with NTN network access based in part on the received information and a location of the wireless device;
upon determining that the wireless device is outside the area with NTN network access, operate in a reduced power mode in which one or more internal processes are suspended or disabled; and
upon determining that the wireless device is within the area with NTN network access, operate in a normal power mode in which one or more of the internal processes that were suspended or disabled are reactivated or enabled.

12. The wireless device of claim 11, wherein the processing circuitry operates in the reduced power mode by modifying wireless device configuration.

13. The wireless device of claim 12, wherein the processing circuitry is operable to modify wireless device configuration by one or more of:
entering an inactive state;
adapting paging occasions to periods of network availability and network unavailability; and
adapting discontinuous reception cycles to periods of network availability and unavailability.

14. The wireless device of claim 11, wherein the processing circuitry operates in the reduced power mode by suspending a wireless device operation.

15. The wireless device of claim 14, wherein the processing circuitry is operable to suspend the wireless device operation by suspending one or more of:
cell search;
page monitoring;
neighbor cell measurements;
periodic registration;
periodic area updates;
system information acquisition; and
reachability timer monitoring.

16. The wireless device of claim 11, wherein the processing circuitry is operable to operate in the normal power mode by modifying wireless device configuration.

17. The wireless device of claim 16, wherein the processing circuitry is operable to modify wireless device configuration by one or more of:
entering a connected state;
adapting paging occasions to periods of network availability and network unavailability; and
adapting discontinuous reception cycles to periods of network availability and unavailability.

18. The wireless device of claim 11, wherein the processing circuitry operates in the normal power mode by resuming a wireless device operation.

19. The wireless device of claim 18, wherein the processing circuitry is operable to resume the wireless device operation by resuming one or more of:
cell search;
page monitoring;
neighbor cell measurements;
periodic registration;
periodic area updates;
system information acquisition; and
reachability timer monitoring.

20. The wireless device of claim 11, wherein the processing circuitry is operable to receive information indicative of the availability of NTN network access by one or more of:
receiving information related to a shape, size, center, movement, or orientation of an area covered by NTN network access;
receiving explicit information about where NTN network access exists;
receiving explicit information about where NTN network access is absent;
receiving information about one or more borders associated with an area covered by NTN network access; and
receiving coverage timing information indicating when an area will be covered by NTN network access.

21. A method performed by a network node for adapting to intermittent network coverage in a non-terrestrial network (NTN), the method comprising:
providing a wireless device with information indicative of the availability of NTN network access;
obtaining location information associated with the wireless device;
determining whether the wireless device is within or outside of an area with NTN network access based in part on the information indicative of the availability of NTN network access and the obtained location of the wireless device;
upon determining that the wireless device is outside the area with NTN network access, determining that the wireless device is using a reduced power mode of operation in which one or more internal processes are suspended or disabled; and
upon determining that the wireless device is within the area with NTN network access, determining that the wireless device is using a normal power mode of operation in which one or more of the internal processes that were suspended or disabled are reactivated or enabled.

22.-30. (canceled)

31. A network node capable of operating in a non-terrestrial network (NTN), the network node comprising processing circuitry operable to:
provide a wireless device with information indicative of the availability of NTN network access;
obtain location information associated with the wireless device;
determine whether the wireless device is within or outside of an area with NTN network access based in part on the information indicative of the availability of NTN network access and the obtained location of the wireless device;
upon determining that the wireless device is outside the area with NTN network access, determine that the wireless device is using a reduced power mode of operation in which one or more internal processes are suspended or disabled; and
upon determining that the wireless device is within the area with NTN network access, determine that the wireless device is using a normal power mode of operation in which one or more of the internal processes that were suspended or disabled are reactivated or enabled.

32. The network node of claim 31, the processing circuitry further operable to, upon determining that the wireless device is outside the area with NTN network access, suspend a network reachability timer for the wireless device.

33. The network node of claim 31, the processing circuitry further operable to, upon determining that the wireless device is outside the area with NTN network access, adapt a discontinuous reception cycle for the wireless device based in part on the information indicative of the availability of NTN network access and the obtained location of the wireless device.

34. The network node of claim 31, the processing circuitry further operable to, upon determining that the wireless device is outside the area with NTN network access, determine the wireless device autonomously suspended to an inactive state.

35. The network node of claim 31, the processing circuitry further operable to, upon determining that the wireless device is within the area with NTN network access, resume a network reachability timer for the wireless device.

36. The network node of claim 31, the processing circuitry further operable to, upon determining that the wireless device is within the area with NTN network access, adapt a discontinuous reception cycle for the wireless device based in part on the information indicative of the availability of NTN network access and the obtained location of the wireless device.

37. The network node of claim 31, the processing circuitry further operable to, upon determining that the wireless device is within the area with NTN network access, determine the wireless device autonomously resumed to an active state.

38. The network node of claim 31, wherein the processing circuitry is operable to provide the wireless device with information indicative of the availability of NTN network access by providing information related to a shape, size, center, movement, or orientation of an area covered by NTN network access.

39. The network node of claim 31, wherein the processing circuitry is operable to provide the wireless device with information indicative of the availability of NTN network access by one or more of:
providing explicit information about where NTN network access exists;
providing explicit information about where NTN network access is absent; and
providing information about one or more borders associated with an area covered by NTN network access.

40. The network node of claim 31, wherein the processing circuitry is operable to provide the wireless device with information indicative of the availability of NTN network access by providing coverage timing information indicating when an area will be covered by NTN network access.
